(19) United States
(12) Patent Application Publication
(10) Pub. No.: US 2015/0101750 A1
(43) Pub. Date: Apr. 16, 2015

(54) BONDING APPARATUS OF FUEL CELL STACK AND METHOD THEREOF

(71) Applicant: Hyundai Motor Company, Seoul (KR)

(72) Inventors: Junghan YU, Seoul (KR); Kook Il HAN, Seongnam-si (KR)

(73) Assignee: HYUNDAI MOTOR COMPANY, Seoul (KR)

(21) Appl. No.: 14/145,396

(22) Filed: Dec. 31, 2013

(30) Foreign Application Priority Data
Oct. 14, 2013 (KR) 10-2013-0122250

(51) Int. Cl. H01M 8/02

(52) U.S. Cl. CPC H01M 8/0297
USPC 156/308.6; 156/497

(57) ABSTRACT

A bonding apparatus of fuel cell stack includes a lower heat plate provided at one side of a gas diffusion layer provided at both sides of a membrane electrode assembly, the lower heat plate supplying heat to the gas diffusion layer and including a steam supply line for supplying steam to the gas diffusion layer. An upper heat plate is provided at the other side of a gas diffusion layer, the upper heat plate supplying heat to the gas diffusion layer and including a steam supply line for supplying steam to the gas diffusion layer. A controller controls a supply time of the heat and steam to the lower heat plate and the upper heat plate.

### CROSS-REFERENCE TO RELATED APPLICATION

This application claims the benefit of priority to Korean Patent Application No. 10-2013-0122250 filed in the Korean Intellectual Property Office on Oct. 14, 2013, the entire contents of which are incorporated herein by reference.

### TECHNICAL FIELD

The present disclosure relates to a bonding apparatus of fuel cell stack and method. More particularly, the present disclosure relates to a bonding apparatus of fuel cell stack and method that avoid deformation of a polymer electrolyte membrane by supplying steam while a membrane electrode assembly and a gas diffusion layer are bonded, and improving performance by removing moisture remaining at the gas diffusion layer.

### BACKGROUND

As is generally known, a fuel cell is a power generation system that directly converts chemical energy of fuel to electrical energy.

Different types of fuel cells include molten carbonate fuel cell (MCFD), solid oxide fuel cell (SOFC), polymer electrolyte fuel cell (PEFC), phosphoric acid fuel cell (PAFC), and alkali fuel cell (AFC) depending on the type of electrolyte.

As shown in FIG. 1, a membrane electrode assembly (MEA) in the fuel cell stack includes a polymer electrolyte membrane 12, a catalyst layer 11 (anode and cathode) provided in both sides of the polymer electrolyte membrane 12, and a subgasket 13 provided in both sides of catalyst layer 11. The subgasket 13 simplifies handling of the membrane electrode assembly 10.

Referring to FIG. 2, a gas diffusion layer (GDL) 20 is provided in both sides of the membrane electrode assembly 10. A separating plate (not shown), at which a flow field is formed, is located outside of the gas diffusion layer 20 for supplying fuel and air to cathode and anode, and discharging water generated by a chemical reaction.

Hydrogen and oxygen are ionized by the chemical reaction of each catalyst layer 11, thus generating an oxidation reaction at a hydrogen portion and reduction reaction at an oxygen portion.

That is, the hydrogen is supplied to the anode, and the oxygen (air) is supplied to the cathode. Therefore, the hydrogen supplied to the anode is divided into proton (H+) and electron (e−) by a catalyst of an electrode layer provided in both sides of the electrolyte layer. Only the proton (H+) is selectively transferred to the cathode through the electrolyte layer of positive ion exchange layer. Simultaneously, the electron (e−) is transferred to the cathode through the gas diffusion layer 20 and the separating plate.

In the cathode, the proton supplied through the electrolyte layer and the electron supplied through the separating plate have a chemical reaction with the oxygen of air supplied to the cathode by an air supplying apparatus and generate water.

A movement of the proton generates current and heat is generated in a water generating reaction.

When the fuel cell stack is laminated, an integrating process of the membrane electrode assembly 10 and the gas diffusion layer 20 is needed. Generally, the integrating process is divided into following two methods:

First, as shown in FIG. 2(a), a catalyst coated membrane (CCM) directly coats the catalyst layer 11 of the polymer electrolyte membrane 12. The CCM needs a separate process for bonding the gas diffusion layer 20. Because the CCM is separated from the membrane electrode assembly 10 and the gas diffusion layer 20, the membrane electrode assembly 10 and the gas diffusion layer 20 need to be bonded when manufacturing the fuel cell stack by laminating a plurality of unit cells. The CCM bonds to the membrane electrode assembly 10 and the gas diffusion layer 20 by thermal compression.

As shown in FIG. 2(b), catalyst coated substrate (CCS) or catalyst coated gas diffusion layer (CCGDL) directly coating the catalyst layer 11 of the gas diffusion layer 20 bonds the gas diffusion layer 20 and the membrane electrode assembly 10 by thermal compression. Because the CCS bonds the catalyst layer 11 and the polymer electrolyte membrane 12 for manufacturing the membrane electrode assembly 10, the membrane electrode assembly 10 and the gas diffusion layer 20 are bonded by thermal compression.

As shown in FIG. 3, when the membrane electrode assembly 10 and the gas diffusion layer 20 are bonded by thermal compression, an interface 15 is formed between the catalyst layer 11 and the gas diffusion layer 20, and an interface 16 is formed between the gas diffusion layer 20 and the subgasket 13 at the membrane electrode assembly 10 of the CCM.

A fuel cell reaction occurs at the interface 15 which is formed between the catalyst layer 11 and the gas diffusion layer 20, and the fuel cell reaction does not take place at the interface 16 which is formed between the subgasket 13 and the gas diffusion layer 20. The membrane electrode assembly 10 and the gas diffusion layer 20 are thermally compressed after coating an ionomer, such as Nafion, to the gas diffusion layer 20 to improve adherence. But in this case, because a material property of the interface 15 and interface 16 is hydrophilic, the actual performance differs from a required performance.

Further, it is difficult to manage different sizes of each part because of a thermal deformation of the polymer electrolyte membrane 12 when the membrane electrode assembly 10 and the gas diffusion layer 20 are bonded by thermal compression. Particularly, these problems become more serious as the thickness of the polymer electrolyte membrane 12 decreases for smaller sized fuel cells.

In order to obtain sufficient performance of the fuel cell, sufficient moisture needs to be supplied to the polymer electrolyte membrane 12. However, because the membrane electrode assembly 10 and the gas diffusion layer 20 are bonded by thermal compression, the polymer electrolyte membrane 12 is dried, and performance of fuel cell is deteriorated.

The above information disclosed in this Background section is only for enhancement of understanding of the background of the disclosure, and therefore, it may contain information that does not form the prior art that is already known in this country to a person of ordinary skill in the art.

### SUMMARY

The present disclosure provides a bonding apparatus of a fuel cell stack and method that can prevent thermal deformation of a polymer electrolyte membrane when a membrane electrode assembly and a gas diffusion layer are bonded by thermal compression.

Further, the present disclosure provides a bonding apparatus of a fuel cell stack and method that can prevent performance of a fuel cell from degrading by a dry polymer electrolyte membrane when a membrane electrode assembly and a gas diffusion layer are bonded by thermal compression.

A bonding apparatus of a fuel cell stack according to an exemplary embodiment of the present disclosure includes a lower heat plate provided at one side of a gas diffusion layer provided at both sides of a membrane electrode assembly, the lower heat plate supplying heat to the gas diffusion layer and including a steam supply line for supplying steam to the gas diffusion layer. An upper heat plate provided at another side of a gas diffusion layer supplies the heat to the gas diffusion layer and includes a steam supply line for supplying steam to the gas diffusion layer. A controller is configured to control a supply time of the heat and the steam to the lower heat plate and the upper heat plate.

The controller controls the heat and the steam supplied to the lower heat plate and the upper heat plate for a period of time, and thermal compression of the membrane electrode assembly and the gas diffusion layer. The controller further controls that the heat is only supplied to the lower heat plate and the upper heat plate for the period of time, and thermal compression of the membrane electrode assembly and the gas diffusion layer.

The controller controls that the heat is supplied to the lower heat plate and the upper heat plate for a period of time and the membrane electrode assembly and thermal compression of the gas diffusion layer. The controller further controls that the steam is repeatedly supplied to the lower heat plate and the upper heat plate for the period of time while the heat is supplied to the lower heat plate and the upper heat plate.

At least one lower moisture evaporation hole is located at a lower side of the lower heat plate for discharging moisture from the gas diffusion layer to outside, and at least one upper moisture evaporation hole is located at an upper side of the upper heat plate for discharging the moisture from the gas diffusion layer to the outside.

The lower moisture evaporation hole and the upper moisture evaporation hole are located at a center portion of the lower heat plate and the upper heat plate, respectively, and the steam supply line is formed at the outside of the moisture evaporation hole.

The steam supply line and the lower moisture evaporation hole located at the lower heat plate communicate with each other, and the steam supply line and the upper moisture evaporation hole located at the upper heat plate communicate with each other. The lower moisture evaporation hole and the upper moisture evaporation hole are able to be opened and closed.

A manufacturing method of fuel cell stack according to an exemplary embodiment of the present disclosure includes thermally compressing a membrane electrode assembly and a gas diffusion layer by supplying heat and steam for a period of time through a lower heat plate and an upper heat plate provided at both sides of the membrane electrode assembly. Residual moisture in the gas diffusion layer is removed by supplying heat to the membrane electrode assembly and the gas diffusion layer through the lower heat plate and the upper heat plate for the period of time.

The residual moisture in the gas diffusion layer is discharged through a moisture evaporation holes located at a lower side of the lower heat plate and an upper side of the upper heat plate, respectively.

A manufacturing method of fuel cell stack according to another exemplary embodiment of the present disclosure includes thermally compressing a membrane electrode assembly and a gas diffusion layer by supplying heat and steam for a period of time through the gas diffusion layer provided at both sides of a membrane electrode assembly. Moisture is repeatedly supplied for the period of time while heat is supplied to the membrane electrode assembly and the gas diffusion layer through the lower heat plate and the upper heat plate.

Residual moisture in the gas diffusion layer is discharged through a moisture evaporation holes respectively located at a lower side of the lower heat plate and an upper side of the upper heat plate.

### BRIEF DESCRIPTION OF THE DRAWINGS

The drawings are provided for reference in describing exemplary embodiments of the present disclosure, and the spirit of the present disclosure should not be construed only by the accompanying drawings.

FIG. 1 schematically shows a general membrane electrode assembly.

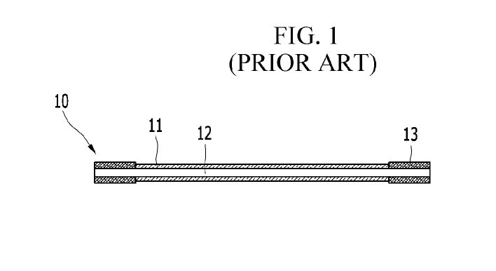

FIG. 2 schematically shows a bonding method of a membrane electrode assembly and a gas diffusion layer according to the conventional art.

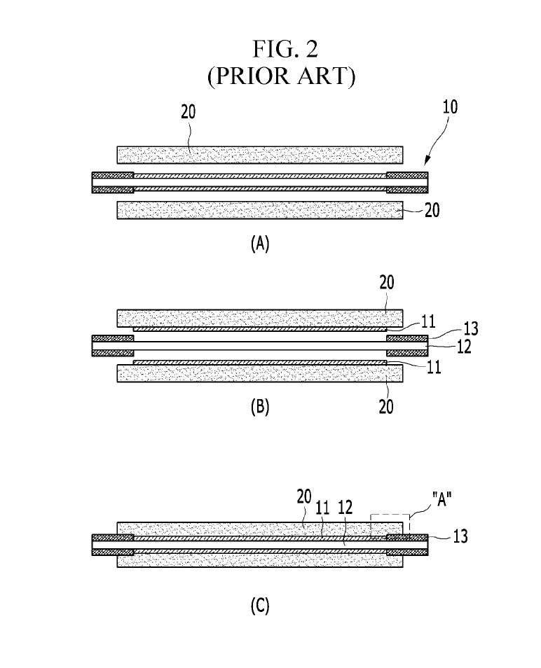

FIG. 3 is a partially enlarged view of FIG. 2(A).

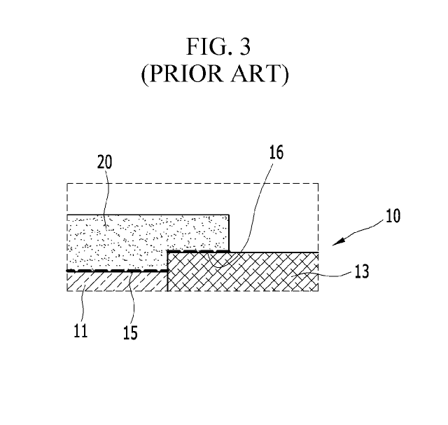

FIG. 4 schematically shows a bonding apparatus of fuel cell stack according to an exemplary embodiment of the present disclosure.

FIG. 5 schematically shows a top plane view of a lower heat plate and upper heat plate according to an exemplary embodiment of the present disclosure.

FIG. 6 schematically shows a bonding process of a membrane electrode assembly and a gas diffusion layer according to an exemplary embodiment of the present disclosure.

FIG. 7 schematically shows a graph temperature profile when a membrane electrode assembly and a gas diffusion layer are bonded according to an exemplary embodiment of the present disclosure.

FIG. 8 schematically shows a bonding process of a membrane electrode assembly and a gas diffusion layer according to another exemplary embodiment of the present disclosure.

FIG. 9 shows a graph of a steam supplying process according to time when a membrane electrode assembly and a gas diffusion layer are bonded according to another exemplary embodiment of the present disclosure.

### DETAILED DESCRIPTION

The present disclosure will be described more fully hereinafter with reference to the accompanying drawings, in which exemplary embodiments of the disclosure are shown. As those skilled in the art would realize, the described embodiments may be modified in various different ways, all without departing from the spirit or scope of the present disclosure.

In order to clearly describe the present disclosure, portions that are not connected with the description will be omitted. Like reference numerals designate like elements throughout the specification.

In addition, the size and thickness of each configuration shown in the drawings are arbitrarily shown for better understanding and ease of description, but the present disclosure is not limited thereto. In the drawings, the thickness of layers, films, panels, regions, etc., are exaggerated for clarity.

A bonding apparatus of a fuel cell stack according to an exemplary embodiment of the present disclosure relates to a bonding apparatus of a membrane electrode assembly of fuel cell and a gas diffusion layer provided in both sides of the membrane electrode assembly.

The membrane electrode assembly comprises a polymer electrolyte membrane, a catalyst layer (anode and cathode) provided at both sides of the polymer electrolyte membrane, and a subgasket provided at both sides of the catalyst layer. The gas diffusion layer (GDL) is provided at both sides of the membrane electrode assembly.

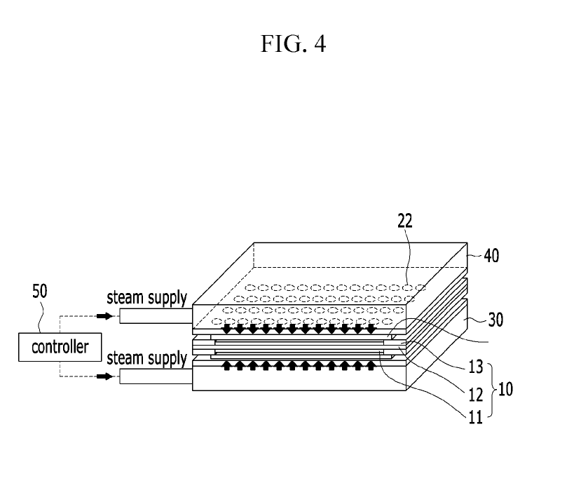

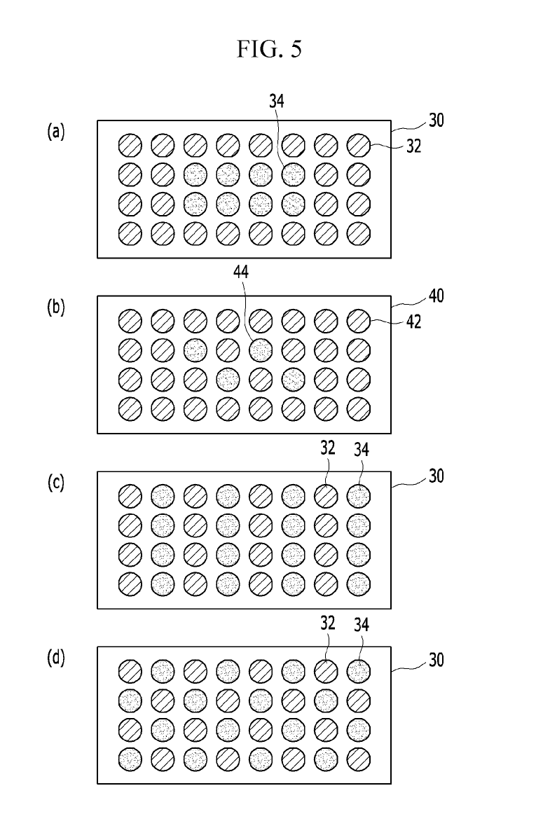

FIG. 4 schematically shows a bonding apparatus of a fuel cell stack according to an exemplary embodiment of the present disclosure, and FIG. 5 schematically shows a top plane view of a lower heat plate and upper heat plate according to an exemplary embodiment of the present disclosure.

As shown in FIGS. 4 and 5, the bonding apparatus of fuel cell stack includes a lower heat plate 30 provided at one side of a gas diffusion layer 20 provided at both sides of a membrane electrode assembly 10, the lower heat plate 30 supplying heat to the gas diffusion layer 20, and including a steam supply line 32 for supplying steam to the gas diffusion layer 20. An upper heat plate 40 is provided at the other side of the gas diffusion layer 20, supplies heat to the gas diffusion layer, and includes a steam supply line 42 for supplying steam to the gas diffusion layer 20. A controller controls a supply time of the heat and the steam to the lower heat plate 30 and the upper heat plate 40.

The lower heat plate 30 and the upper heat plate 40, which are supplied with heat from a heat source (not shown), thermally compress the membrane electrode assembly 10 and the gas diffusion layer 20.

The steam supply line 32, which is supplied with the steam from a steam source (not shown) and supplies the steam to the membrane electrode assembly 10 and the gas diffusion layer 20, is formed in the lower heat plate 30 and the upper heat plate 40. When the membrane electrode assembly 10 and the gas diffusion layer 20 are thermally compressed, if moisture is supplied to the membrane electrode assembly 10, it is possible to prevent the polymer electrolyte membrane 12 from deforming. Particularly, thermal deformation is increased as the thickness of the polymer electrolyte membrane f12 is thinned according to downsize of fuel cell stack. Therefore, it is possible to manage different sizes of each part when the moisture is supplied to the membrane electrode assembly 10.

FIG. 5 schematically shows a top plane view of a lower heat plate and upper heat plate according to an exemplary embodiment of the present disclosure.

As shown in FIG. 5, at least one lower moisture evaporation hole 34 is formed at a lower side of the lower heat plate 30. The lower moisture evaporation hole 34 discharges moisture generated at the gas diffusion layer 20. At least one upper moisture evaporation hole (not shown) is formed at an upper side of the upper heat plate 40. The upper moisture evaporation hole discharges the moisture generated at the gas diffusion layer 20.

When the heat and moisture are supplied through the lower heat plate 30 and the upper heat plate 40, residual moisture is evaporated between the lower heat plate 30 and the upper heat plate 40. In such a case, it is difficult to evaporate the moisture remained at a center portion of the gas diffusion layer 20. Therefore, the membrane electrode assembly 10 and the gas diffusion layer 20 are non-uniformly bonded, and the actual performance of the fuel cell may be different from a predicted performance.

The moisture is discharged through the moisture evaporation holes 34, 44 formed at the lower heat plate 30 and the upper heat plate 40, thereby uniformly bonding the membrane electrode assembly 10 and the gas diffusion layer 20, and improving performance and durability of the fuel cell.

A plurality of moisture evaporation holes 34, 44 may be formed at the lower heat plate 30 and the upper heat plate 40. As shown in FIG. 5, an arrangement of the moisture evaporation holes 34, 44 may vary.

As shown in FIGS. 5(a) and 5(b), the moisture evaporation holes 34, 44 are densely disposed at a center portion of the lower heat plate 30 and the upper heat plate 40. A plurality of steam supply lines 32, 42 are disposed outside of the moisture evaporation holes 34. In such a case, the residual moisture at the gas diffusion layer 20 is efficiently discharged.

As shown in FIGS. 5(c) and 5(d), the moisture evaporation hole 34 and steam supply line 32 may be alternatively disposed. Thus, the membrane electrode assembly 10 and the gas diffusion layer 20 may be uniformly bonded.

The moisture evaporation hole 34 may communicate with the steam supply line 32, and the moisture evaporation hole 34 may be able to be opened and closed.

When the moisture evaporation holes located at the lower heat plate 30 and the upper heat plate 40 are closed, the moisture is supplied to the gas diffusion layer 20. When the moisture evaporation holes are opened, the residual moisture at the gas diffusion layer 20 is discharged to the outside.

Hereinafter, a bonding process of the membrane electrode assembly 10 and the gas diffusion layer 20 will be described in detail using the bonding apparatus of fuel cell stack according to an exemplary embodiment of the present disclosure.

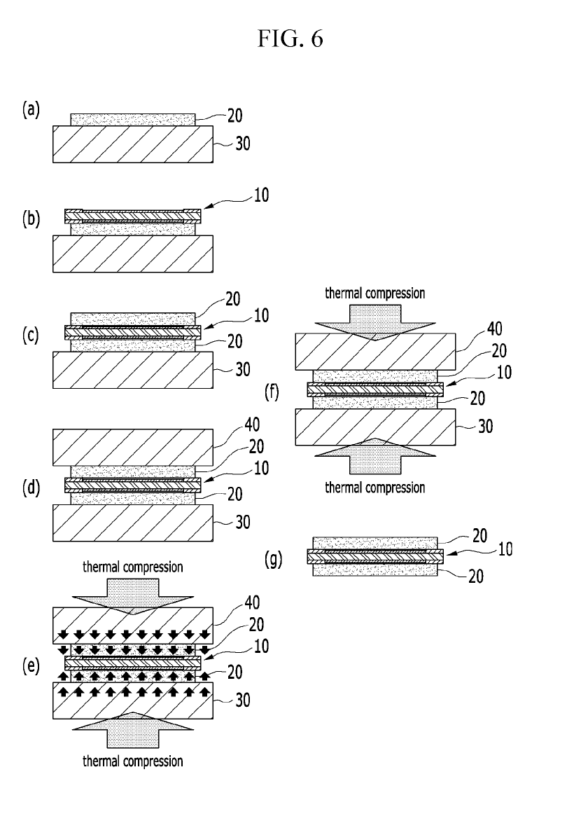

FIG. 6 schematically shows a bonding process of a membrane electrode assembly and a gas diffusion layer according to an exemplary embodiment of the present disclosure.

As shown in FIGS. 6(a) to 6(d), the gas diffusion layer 20 is disposed at an upper side of the lower heat plate 30. The membrane electrode assembly 10 is disposed at an upper side of the gas diffusion layer 20, and another gas diffusion layer 20 is disposed at an upper side of the membrane electrode assembly 10. The upper heat plate 40 is disposed at upper side of the another gas diffusion layer 20.

Referring to FIGS. 6(e) to 6(g), the membrane electrode assembly 10 and a pair of gas diffusion layers 20 are disposed between the upper heat plate 40 and the lower heat plate 30, and heat and steam are supplied to the membrane electrode assembly 10 and the pair of gas diffusion layers 20 through the upper heat plate 40 and the lower heat plate 30 for a period of time, thereby bonding the membrane electrode assembly 10 with the pair of gas diffusion layers 20. After the membrane electrode assembly 10 and the pair of gas diffusion layers 20 are thermally compressed for the period of time while heat and steam are supplied, the membrane electrode assembly 10 and the pair of gas diffusion layers 20 are thermally compressed for a period of time while only heat is supplied. Finally, the gas diffusion layer 20 is separated from the upper heat plate 40 and the lower heat plate 30.

As such, the membrane electrode assembly 10 and the pair of gas diffusion layers 20 are thermally compressed for a period of time while only heat is supplied, thereby maintaining a constant amount of moisture in the polymer electrolyte membrane 12 and discharging residual moisture in the gas diffusion layer 20.

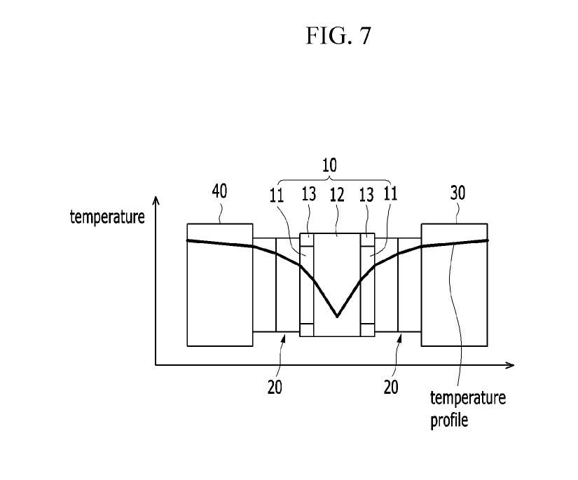

As shown in FIG. 7, if the membrane electrode assembly 10 and the gas diffusion layer 20 are thermally compressed, a temperature of the polymer electrolyte membrane 12 is relatively low compared with a temperature of the gas diffusion layer 20. Therefore, the residual moisture in the gas diffusion layer 20 can be discharged, and thereby, the gas diffusion layer 20 is dried. Because the temperature of the polymer electrolyte membrane 12 is relatively low, the residual moisture in the gas diffusion layer 20 may not discharged easily.

Also, as shown in FIG. 5, moisture in the gas diffusion layer 20 is discharged through the moisture evaporation hole 34 formed at the upper heat plate 40 and the lower heat plate 30, respectively.

According to another exemplary embodiment of present disclosure, a bonding process of the membrane electrode assembly 10 and the gas diffusion layer 20 will be described in detail using the bonding apparatus of a fuel cell stack.

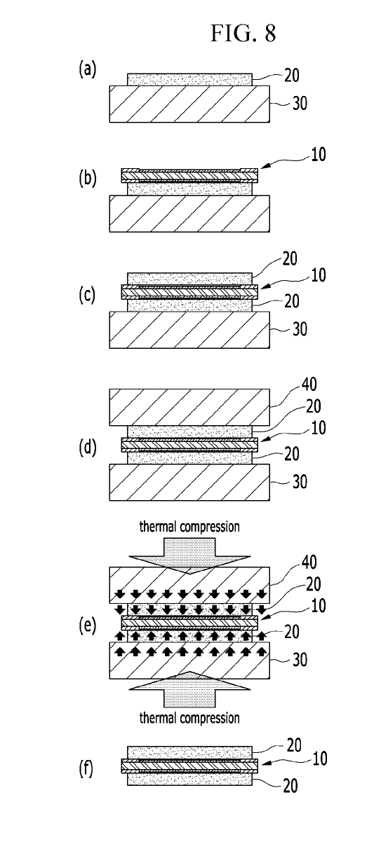

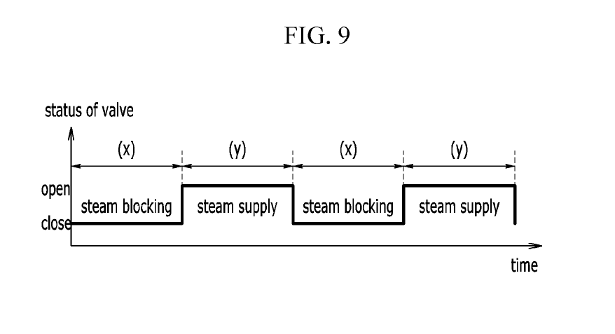

FIG. 8 schematically shows a bonding process of a membrane electrode assembly and a gas diffusion layer according to another exemplary embodiment of the present disclosure, and FIG. 9 shows a graph of a steam supplying process and the time when a membrane electrode assembly and a gas diffusion layer are bonded according to another exemplary embodiment of the present disclosure.

Referring to FIGS. 8(a) to 8(d), the gas diffusion layer 20 is disposed at an upper side of the lower heat plate 30. The membrane electrode assembly 10 is disposed at an upper side of the gas diffusion layer 20, and another gas diffusion layer 20 is disposed at upper side of the membrane electrode assembly 10. The upper heat plate 40 is disposed at an upper side of another gas diffusion layer 20.

Referring to FIG. 8(e), when the membrane electrode assembly 10 and a pair of gas diffusion layer 20 are disposed between the upper heat plate 40 and the lower heat plate 30, heat and steam are supplied to the membrane electrode assembly 10 and the pair of gas diffusion layers 20 through the upper heat plate 40 and the lower heat plate 30 for a period of time, thereby bonding the membrane electrode assembly 10 and the pair of gas diffusion layer 20.

FIG. 9 shows a graph of a steam supplying process and time when a membrane electrode assembly and a gas diffusion layer are bonded according to another exemplary embodiment of the present disclosure. In FIG. 9, the horizontal axis means time, and the vertical axis means opening/closing status of moisture supply valve provided at the steam supply line.

As shown in FIG. 9, moisture supplied from the upper heat plate 40 and the lower heat plate 30 is supplied for a period of time and repetitively blocked for a period of time. That is, in a (x) period not supplying moisture, residual moisture in the gas diffusion layer 20 is discharged to the outside. In a (y) period supplying moisture, the moisture is supplied to the polymer electrolyte membrane 12, thereby preventing the polymer electrolyte membrane 12 from deforming.

A bonding performance according to a characteristic of the membrane electrode assembly 10 and the gas diffusion layer 20 can be appropriately optimized by controlling the supply time and blocking time of the moisture.

Further, as shown in FIG. 5, the residual moisture in the gas diffusion layer 20 is smoothly discharged through the moisture evaporation holes 34, 44 formed at the upper heat plate 40 and the lower heat plate 30.

As described above, according to the bonding apparatus of a fuel cell stack and method of an exemplary embodiment of the present disclosure, the polymer electrolyte membrane 12 is prevented from deforming by supplying moisture to the polymer electrolyte membrane 12, thus maintaining the dimensions of the polymer electrolyte membrane 12. Particularly, since thermal deformation is increased as the thickness of the polymer electrolyte membrane 12 is thinned, it is necessary to maintain the thickness of the polymer electrolyte membrane 12.

In addition, after the membrane electrode assembly 10 and the gas diffusion layer 20 are bonded, sufficient moisture is supplied to the polymer electrolyte membrane 12 when operating the fuel cell, thereby maintaining a constant performance. According to the bonding apparatus of a fuel cell stack of the present disclosure, the polymer electrolyte membrane 12 contains a constant amount of moisture, thereby reducing an activation process time. Residual moisture in the gas diffusion layer 20 is removed, thereby improving performance of the fuel cell.

According to the bonding apparatus of a fuel cell stack and method of an exemplary embodiment of the present disclosure, moisture is supplied to the polymer electrolyte membrane 12 and moisture supplied to ionomer is dispensed to the catalyst layer 11. Therefore, a bonding force of the gas diffusion layer 20 and the polymer electrolyte membrane 12 is improved. Accordingly, the gas diffusion layer 20 and the polymer electrolyte membrane 12 are not separated from each other when the fuel cell stack is manufactured, a rejection rate of the fuel cell stack is reduced, and the manufacturing time is reduced according to the decrement of the rejection rate.

According to the bonding apparatus of a fuel cell stack and method of an exemplary embodiment of the present disclosure, moisture is supplied to the polymer electrolyte membrane when the membrane electrode assembly and the gas diffusion layer are bonded by thermal compression. Therefore, contraction of the polymer electrolyte membrane is prevented, and dimensional stability is obtained.

Further, sufficient moisture is supplied to the polymer electrolyte membrane, and residual moisture is removed in the gas diffusion layer. Therefore, performance of the fuel cell is improved. A bonding force of the catalyst layer is improved by supplying the moisture to the polymer electrolyte membrane, thus preventing the catalyst layer from being separated from the polymer electrolyte membrane.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. A bonding apparatus of a fuel cell stack comprising:
a lower heat plate provided at one side of a gas diffusion layer provided at both sides of a membrane electrode assembly, the lower heat plate supplying heat to the gas diffusion layer and including a steam supply line for supplying steam to the gas diffusion layer;
an upper heat plate provided at another side of the gas diffusion layer, the upper heat plate supplying heat to the gas diffusion layer and including a steam supply line for supplying steam to the gas diffusion layer; and
a controller configured to control a supply time of the heat and the steam to the lower heat plate and the upper heat plate.

2. The bonding apparatus of a fuel cell stack of claim 1, wherein the controller controls
that the heat and steam supplied to the lower heat plate and the upper heat plate for a period of time and thermal compression of the membrane electrode assembly and the gas diffusion layer, and
heat is supplied only to the lower heat plate and the upper heat plate for a period of time and thermal compression of the membrane electrode assembly and the gas diffusion layer.

3. The bonding apparatus of a fuel cell stack of claim 1, wherein the controller controls
the heat supplied to the lower heat plate and the upper heat plate for a period of time and thermal compression of the membrane electrode assembly and the gas diffusion layer, and
repeatedly supplying the steam to the lower heat plate and the upper heat plate for a period of time while the heat is supplied to the lower heat plate and the upper heat plate.

4. The bonding apparatus of a fuel cell stack of claim 1,
wherein at least one lower moisture evaporation hole is formed at a lower side of the lower heat plate for discharging moisture from the gas diffusion layer to outside, and
at least one upper moisture evaporation hole is formed at an upper side of the upper heat plate for discharging the moisture from the gas diffusion layer to the outside.

5. The bonding apparatus of a fuel cell stack of claim 4,
wherein the lower moisture evaporation hole and the upper moisture evaporation hole are located at a center portion of the lower heat plate and the upper heat plate, and
the steam supply line is located at the outside of the moisture evaporation holes.

6. The bonding apparatus of a fuel cell stack of claim 4,
wherein the steam supply line and the lower moisture evaporation hole formed at the lower heat plate communicate with each other,
the steam supply line and the upper moisture evaporation hole formed at the upper heat plate communicate with each other, and
the lower moisture evaporation hole and the upper moisture evaporation hole are formed to be able to open and close.

7. A manufacturing method of a fuel cell stack comprising:
thermally compressing a membrane electrode assembly and a gas diffusion layer by supplying heat and steam for a period of time through a lower heat plate and an upper heat plate provided at both sides of the membrane electrode assembly; and
removing residual moisture in the gas diffusion layer by supplying the heat to the membrane electrode assembly and the gas diffusion layer through the lower heat plate and the upper heat plate for a period of time.

8. The manufacturing method of a fuel cell stack of claim 7,
wherein the residual moisture in the gas diffusion layer is discharged through a moisture evaporation hole at a lower side of the lower heat plate and an upper side of the upper heat plate.

9. A manufacturing method of a fuel cell stack comprising:
thermally compressing a membrane electrode assembly and a gas diffusion layer by supplying heat and steam for a period of time through the gas diffusion layer provided at both sides of the membrane electrode assembly; and
repeatedly supplying moisture for the period of time while the heat is supplied to the membrane electrode assembly and the gas diffusion layer through a lower heat plate and an upper heat plate.

10. The manufacturing method of a fuel cell stack of claim 9,
wherein residual moisture in the gas diffusion layer is discharged through a moisture evaporation hole respectively formed at a lower side of the lower heat plate and an upper side of the upper heat plate.

11. The bonding apparatus of a fuel cell stack of claim 2,
wherein at least one lower moisture evaporation hole is located at a lower side of the lower heat plate for discharging moisture from the gas diffusion layer to outside, and
at least one upper moisture evaporation hole is located at an upper side of the upper heat plate for discharging the moisture from the gas diffusion layer to the outside.

12. The bonding apparatus of a fuel cell stack of claim 3,
wherein at least one lower moisture evaporation hole is located at a lower side of the lower heat plate for discharging moisture from the gas diffusion layer to outside, and
at least one upper moisture evaporation hole is located at an upper side of the upper heat plate for discharging the moisture from the gas diffusion layer to the outside.

13. The bonding apparatus of a fuel cell stack of claim 11,
wherein the lower moisture evaporation hole and the upper moisture evaporation hole are located at a center portion of the lower heat plate and the upper heat plate, respectively, and
the steam supply line is located at the outside of the moisture evaporation hole.

14. The bonding apparatus of a fuel cell stack of claim 11,
wherein the steam supply line and the lower moisture evaporation hole communicate with each other,
the steam supply line and the upper moisture evaporation hole communicate with each other, and
the lower moisture evaporation hole and the upper moisture evaporation hole are able to be opened and closed.

15. The bonding apparatus of a fuel cell stack of claim 12,
wherein the lower moisture evaporation hole and the upper moisture evaporation hole are located at a center portion of the lower heat plate and the upper heat plate, respectively, and
the steam supply line is located at the outside of the moisture evaporation hole.

16. The bonding apparatus of a fuel cell stack of claim 12,
wherein the steam supply line and the lower moisture evaporation hole communicate with each other,
the steam supply line and the upper moisture evaporation hole communicate with each other, and
the lower moisture evaporation hole and the upper moisture evaporation hole are able to be opened and closed.
